(19) United States
(12) Patent Application Publication
(10) Pub. No.: US 2008/0145623 A1
(43) Pub. Date: Jun. 19, 2008

(54) FILTER FOR PLASMA DISPLAY APPARATUS, PLASMA DISPLAY APPARATUS INCLUDING THE SAME, AND RELATED TECHNOLOGIES

(75) Inventor: Dongoh SHIN, Suwon-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/957,109

(22) Filed: Dec. 14, 2007

(30) Foreign Application Priority Data
Dec. 15, 2006 (KR) 10-2006-0128537

(51) Int. Cl. B32B 3/10; B32B 9/04; B32B 17/06

(52) U.S. Cl. 428/195.1; 428/411.1; 428/426; 428/690

(57) ABSTRACT

A plasma display apparatus is disclosed. The plasma display apparatus includes: a front substrate; scan electrodes and sustain electrodes arranged on the front substrate; a rear substrate arranged apart a predetermined distance from the front substrate; data electrodes arranged to intersect the scan electrode and the sustain electrode in the rear substrate; barrier ribs disposed to partition a discharge cell between the front substrate and the rear substrate; a phosphor formed within the discharge cell to discharge visible light; and an electromagnetic interference shielding layer including a polymerized silver and the electromagnetic interference shielding layer is disposed on the front substrate.

This nonprovisional application claims priority under 35 U.S.C. § 119(a) on Patent Application No. 10-2006-0128537 filed in Korea on Dec. 15, 2006 the entire contents of which are hereby incorporated by reference.

### BACKGROUND

1. Field

This document relates to a filter for a plasma display apparatus, a plasma display apparatus including the same, and related technologies.

2. Related Art

In general, a plasma display apparatus includes a plasma display panel for displaying an image using a plasma discharge, and a filter for a display disposed on a front surface of the plasma display panel.

In the plasma display panel, a barrier rib formed between a front panel and a rear panel forms a unit discharge cell, and each cell is filed with an inert gas containing a main discharge gas such as neon (Ne), helium (He), or a mixed gas (Ne+He) of neon and helium and a small quantity of xenon. A plurality of unit discharge cells constitutes one pixel. For example, a red color (R) cell, a green color (G) cell, and a blue color (B) cell constitute one pixel.

When a high frequency voltage is applied to the unit discharge cell to generate a discharge, an inert gas generates vacuum ultraviolet rays and enables a phosphor formed between barrier ribs to emit light, thereby embodying an image.

A filter for a display having a predetermined function is disposed on a front surface of the plasma display panel. The filter for the display includes an electromagnetic interference shielding layer formed in a predetermined pattern through the use of an etching method using copper. This method involves a high cost and many processes, thereby having a long manufacturing time.

### SUMMARY

An aspect of this document is to provide a filter for a plasma display panel that can be plasticized at a low temperature.

Another aspect of this document is to provide a plasma display panel that can simplify a manufacturing process using a filter for a plasma display panel that can be plasticized at a low temperature, which may be useful in reducing manufacturing costs.

In one aspect, a filter for a plasma display panel includes: a base layer; and an electromagnetic interference shielding layer including silver mixed with an organic material and disposed on the base layer, and the electromagnetic interference shielding layer is positioned at an upper part of the base layer.

Implementations may include one or more of the following features. For example, the base layer may include glass or film.

The base layer may include at least one of a near-infrared ray blocking material and a color temperature correcting material.

An another aspect, a plasma display apparatus includes: a front substrate; scan electrodes and sustain electrodes arranged on the front substrate; a rear substrate arranged apart a predetermined distance from the front substrate; data electrodes arranged to intersect the scan electrodes and the sustain electrodes in the rear substrate; barrier ribs disposed to partition a discharge cell between the front substrate and the rear substrate; a phosphor formed within the discharge cell to discharge visible light; and an electromagnetic interference shielding layer including a polymerized silver and arranged on the front substrate.

Implementations may include one or more of the following features. For example, the electromagnetic interference shielding layer may be positioned directly on the front substrate.

The plasma display apparatus may further include a base film layer between the front substrate and the electromagnetic interference shielding layer, wherein the base film layer may include at least one of a near-infrared ray blocking material and a color temperature correcting material.

It is to be understood that both the foregoing general description and the following detailed description are exemplary and explanatory and are intended to provide further explanation of this document.

### BRIEF DESCRIPTION OF THE DRAWINGS

The details of one or more implementations are set forth in the accompanying drawings and the description below. In the entire description of this document, like reference numerals represent corresponding parts throughout various figures.

FIG. 1 is a cross-sectional view illustrating a filter for a plasma display apparatus in an implementation;

FIGS. 2(1) to 2(12) are diagrams illustrating organic silver structures that may be included in an electromagnetic interference shielding layer;

FIG. 3 is a cross-sectional view illustrating a filter for a plasma display apparatus in another implementation;

FIG. 4 is a perspective view illustrating a plasma display apparatus in an implementation;

FIGS. 5(a), 5(b) and 6 are cross-sectional views illustrating a structure of a filter formed in an upper surface of a front substrate of a plasma display panel in an implementation; and

FIGS. 7(1), 7(2) and 7(3) are views illustrating a method of forming an electromagnetic interference shielding layer in a plasma display panel in an implementation.

### DETAILED DESCRIPTION

Hereinafter, implementations of this document will be described in detail with reference to the accompanying drawings.

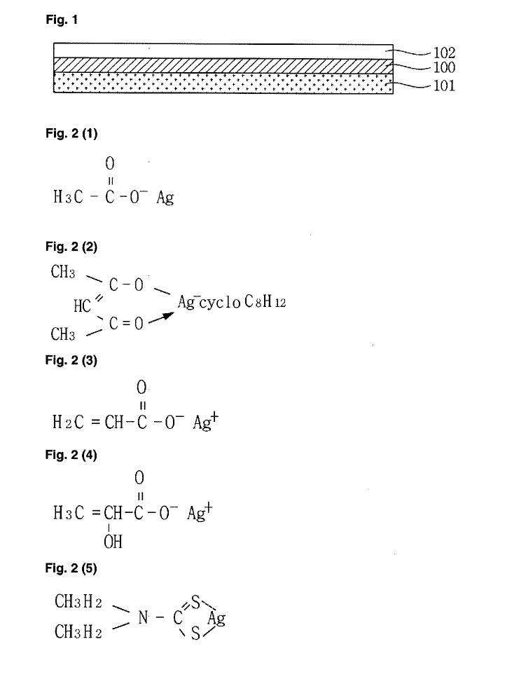

FIG. 1 is a cross-sectional view illustrating a filter for a plasma display apparatus in an implementation.

Referring to FIG. 1, the filter for the plasma display apparatus includes a base film layer 101, an electromagnetic interference shielding layer 100, and a cover film layer 102. The base film layer 101 is made of polyethyleneterephthalate (PET) film, tantalum carvide (TAC) film, glass having transparency.

The base film layer 101 may include at least one of a near-infrared ray blocking material and a color temperature correcting material. The near-infrared ray blocking material can use at least one of near-infrared ray blocking pigment or near-infrared ray blocking dye, and the color correcting material can also use at least one of color correcting pigment or color correcting dye.

The electromagnetic interference shielding layer 100 is formed in an upper part of the base film layer 101. The electromagnetic interference shielding layer 100 includes a mesh type electromagnetic interference shielding layer for forming a conductor in a mesh shape on the base film layer 101 and a sputtering type electromagnetic interference shielding layer in which a conductive layer is formed between two dielectric layers.

The mesh type electromagnetic interference shielding layer may be formed with a photosensitive etching method that has been conventionally generally used and/or a direct patterning method that can reduce a manufacturing cost with a simple process. The direct patterning method includes screen printing, off-set, and dispensing.

The electromagnetic interference shielding layer 100 can be formed by including copper in an electromagnetic interference shielding paste that has binder and solvent; however, the electromagnetic interference shielding layer 100 may alternatively be formed using an electromagnetic interference paste including a mixture of silver and an organic material (i.e., polymerized silver). Because the electromagnetic interference shielding paste including polymerized silver can be plasticized at a temperature of 250 degrees or less, the electromagnetic interference shielding paste can be directly arranged in a front panel of the plasma display panel.

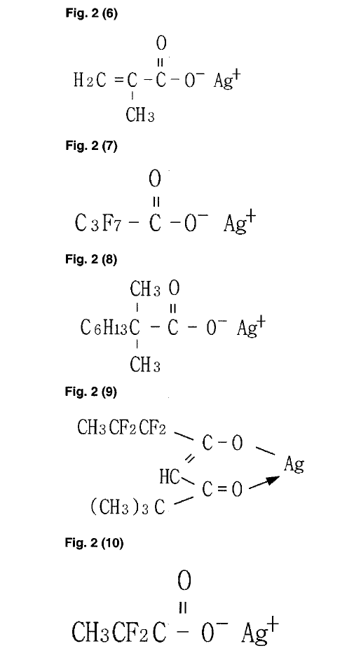

As shown in FIG. 2, a composition of organic silver may include one or more of “silver acetate” shown in FIG. 2(1), “silver hexafluoropentanedionate cyclooctadiene complex” shown in FIG. 2(2), “silver acrylate” shown in FIG. 2(3), “silver lactate” shown in FIG. 2(4), “silver diethydithiocarbamate” shown in FIG. 2(5), “silver methacrylate” shown in FIG. 2(6), “silver heptafluorobutylate” shown in FIG. 2(7), “silver neodicanoate” shown in FIG. 2(8), “silver 6,6,7,7,8,8,8-heptafluoro-2,2-dimethyl-3,5-octanedionate” shown in FIG. 2(9), “silver pentafluoropropionate” shown in FIG. 2(10), “silver p-Toluenesulfonate” shown in FIG. 2(11), and “silver 2,4-pentanedionate” shown in FIG. 2(12).

A cover film 102 for protecting the electromagnetic interference shielding layer 100 is formed in an upper part of the electromagnetic interference shielding layer 100, and the cover film 102 is made of a PET film or a TAC film having transparency.

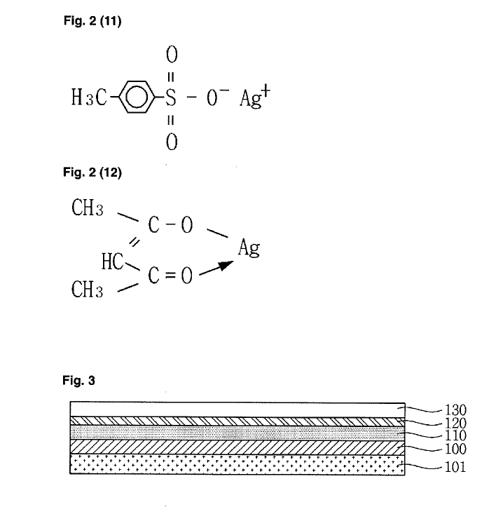

FIG. 3 is a cross-sectional view illustrating a filter for a plasma display apparatus in another implementation.

Referring to FIG. 3, the filter for the plasma display apparatus includes a base film layer 101 and a functional layer, for example the electromagnetic interference shielding layer 100, a near-infrared ray blocking layer 110, a color temperature correction layer 120, and an anti-reflection layer 130.

A structure and a material of one or both of the base film layer 101 and the electromagnetic interference shielding layer 100 may be identical with those of the filter for the plasma display apparatus described in the implementation of FIG. 1, and therefore, a detailed description thereof is omitted.

The near-infrared ray blocking layer 110 and the color temperature correction layer 120 may be sequentially arranged in the upper part of the electromagnetic interference shielding layer 100 or only one thereof may be arranged in the upper part of the electromagnetic interference shielding layer 100.

The near-infrared ray blocking layer 110 can shield a near infrared ray induced from an inert gas such as neon (Ne) and xenon (Xe) filled within the plasma display panel. Therefore, an erroneous operation that may be generated according to a wavelength of a control signal otherwise generating from a remote controller of household electric appliances can be prevented.

Further, the color temperature correction layer 120 can correct orange color light, such as that generated by neon (Ne) if used within the plasma display panel.

The anti-reflection layer 130 can be arranged in an upper part of the near-infrared ray blocking layer 110 or the color temperature correction layer 120; however, in this case, the anti-reflection layer 130 can reduce reflection of light applied from the outside by forming the outermost layer of the filter. Further, although not shown in the drawing, the anti-reflection layer 130 can be directly formed in the upper part of the electromagnetic interference shielding layer 100 without the near-infrared ray blocking layer 110 and the color temperature correction layer 120.

The anti-reflection layer 130 may include a plurality of materials having a different refractive index and a material having a different size. The material having a different size may be an identical material or a different material.

Although not shown, the functional layers can be coupled by adhesives.

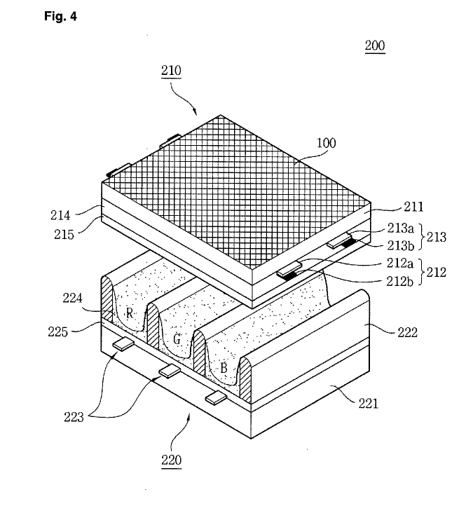

FIG. 4 is a perspective view illustrating a plasma display apparatus in an implementation.

As shown in FIG. 4, the plasma display apparatus includes a plasma display panel 200 and an electromagnetic interference shielding layer 100.

The plasma display panel 200 includes a plurality of electrodes, for example a scan electrode Y, a sustain electrode Z, and an address electrode X, and drivers formed in a driving circuit board (not shown) supply a driving voltage to the electrodes to generate a discharge, thereby embodying an image. An example of a structure of the plasma display panel 200 is described in detail as follows.

As shown in FIG. 4, in the plasma display panel 200, a front panel 210 in which a plurality of sustain electrode pairs in which scan electrodes 212 and sustain electrodes 213 are formed in pairs are arranged in a front substrate 211, which is a display surface in which an image is displayed and a rear panel 220 in which a plurality of data electrodes 223 is arranged to intersect the plurality of sustain electrode pairs on a rear substrate 221 forming a rear surface are coupled parallel to each other and apart a predetermined of distance from each other.

The front panel 210 includes pairs of the scan electrode 212 and the sustain electrode 213 mutually discharging in one discharge cell and for sustaining light emitting of a cell. Each of the scan electrode 212 and the sustain electrode 213 may include a transparent electrode (a) made of a transparent Indium tin oxide (ITO) material and a bus electrode (b) made of a metal material or may include only one of a transparent electrode (a) and a bus electrode (b). The scan electrode 212 and the sustain electrode 213 are covered by at least one upper dielectric layer 214 for limiting a discharge current and insulating between electrode pairs, and a protective layer 215 in which for example magnesium oxide (MgO) is deposited is formed in an upper surface of the upper dielectric layer 214 in order to facilitate a discharge condition.

The rear panel 220 includes a stripe type or well type barrier rib 222 for forming a discharge cell. Further, a plurality of data electrodes 223 for generating vacuum ultraviolet rays by performing an address discharge is disposed in parallel to the barrier rib 222. An R, G, B phosphors 224 for emitting visible rays for displaying an image when an address discharge is performed are coated in an upper side surface of the rear panel 220. A lower dielectric layer 225 for protecting the data electrode 223 is formed between the data electrode 223 and the phosphor 224.

The front panel 210 and the rear panel 220 formed with the above method are coupled through a sealing process, and the electromagnetic interference shielding layer 100 is formed in an upper part of the front substrate 211 of the front panel 210, whereby the plasma display panel 200 is completed.

A driving circuit board (not shown) in which drivers for supplying a driving voltage to electrodes such as the scan electrode 212 (Y), the sustain electrode 213 (Z), and the data electrode 223 (X) of the plasma display panel 200 are formed is disposed on a rear surface of the plasma display panel 200, thereby forming a plasma display apparatus.

When the plasma display panel 200 is driven, a driver (not shown) of the driving circuit board supplies a driving pulse such as a reset pulse, in a predetermined period, for example in a reset period, a scan pulse in an address period, and a sustain pulse in a sustain period to an electrode of the plasma display panel, thereby embodying an image.

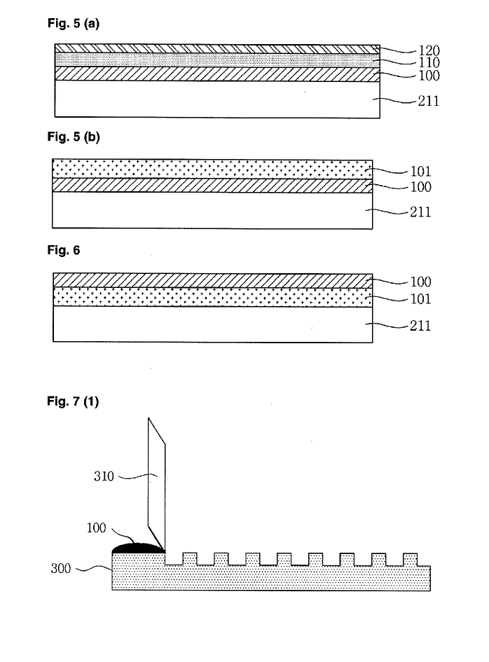

FIGS. 5(a), 5(b) and 6 are cross-sectional views illustrating a structure of a filter formed in an upper part of a front substrate of a plasma display panel in an implementation.

Referring to FIG. 5(a), the electromagnetic interference shielding layer 100 is directly formed on the front substrate 211, and the near-infrared ray blocking layer 110 and the color temperature correction layer 120 are arranged in an upper part of the electromagnetic interference shielding layer 100. In the drawings, both the near-infrared ray blocking layer 110 and the color temperature correction layer 120 are arranged in the upper part of the electromagnetic interference shielding layer 100; however, only one of both may be arranged in the upper part of the electromagnetic interference shielding layer 100. Further, the anti-reflection layer 130 may be formed in an upper part of the color temperature correction layer 120. The anti-reflection layer 130 may include a plurality of materials having a different refractive index and a material having a different size. In this case, the material having a different size may be an identical material or a different material.

Referring to FIG. 5(b), the electromagnetic interference shielding layer 100 is directly formed on the front substrate 211, and the base film layer 101 is formed in the upper part of the electromagnetic interference shielding layer 100. The base film layer 101 may include at least one of a near-infrared ray blocking material and a color temperature correcting material. Further, the anti-reflection layer 130 may be formed in an upper part of the base film layer 101.

Referring to FIG. 6, the base film layer 101 is directly formed on the front substrate 211 and the electromagnetic interference shielding layer 100 is formed in the upper part of the base film layer 101. In this case, the base film layer 101 may include at least one of the near-infrared ray blocking material and the color temperature correcting material. Further, the anti-reflection layer 130 may be formed in the upper part of the base film layer 101.

As shown in FIG. 4, the electromagnetic interference shielding layer 100 formed in the upper part of the front substrate 211 includes polymerized silver, thereby being plasticized at a low temperature.

Because a conventional electromagnetic interference shielding layer is plasticized at a high temperature, the conventional electromagnetic interference shielding layer is not directly formed in a plasma display panel and is separately formed in a filter for a display, whereby many processes are added to form the electromagnetic interference shielding layer in a pattern and to solve a current problem.

However, because an electromagnetic interference shielding layer described in this document can be plasticized at a low temperature, after a front panel and a rear panel are coupled, the electromagnetic interference shielding layer can be formed in an upper part of the front substrate, thereby simplifying a manufacturing process and improving a process yield. Further, the electromagnetic interference shielding layer can be formed with an advantageous method, for example a screen printing method, an offset method, and a dispensing method in a process and a cost. In this case, the electromagnetic interference shielding layer can be formed in a mesh type or a sputtering type.

The electromagnetic interference shielding layer 100 and a method of manufacturing the same in an implementation are described in detail with reference to the drawings.

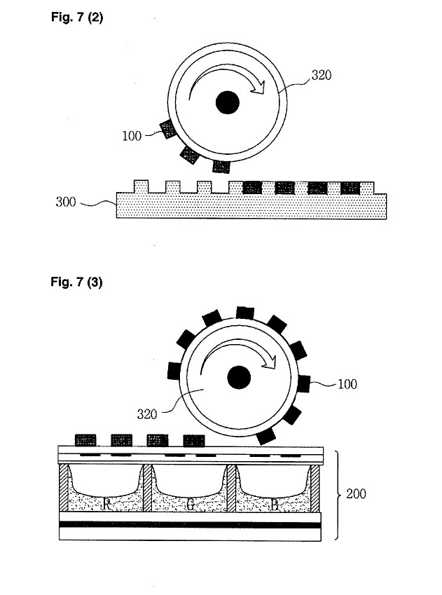

FIGS. 7(1) to 7(3) are views illustrating a method of forming the electromagnetic interference shielding layer 100 in a plasma display panel in an implementation.

As shown in FIGS. 7(1) to 7(3), the electromagnetic interference shielding layer 100 is formed with a direct patterning method, thereby lowering a manufacturing cost. That is, the electromagnetic interference shielding layer can be formed with a direct patterning method that may be comparatively cheaper than photosensitive etching methods.

The electromagnetic interference shielding layer of a filter for a display in an implementation is formed with, for example, the offset method shown in FIGS. 7(1) to 7(3) among direct patterning methods such as a screen printing method, an offset method, and a dispensing method.

As shown in FIG. 7(1), electromagnetic interference shielding paste is coated in a predetermined pattern of printing plate 300 using a blade 310. The electromagnetic interference shielding paste includes binder, solvent, and organic silver. Particularly, because the organic silver enables a plastic process to be achieved at a low temperature, the electromagnetic interference shielding layer can be directly formed in a front panel of a plasma display panel. A composition of the organic silver has been already described and therefore a detailed description thereof is omitted.

Thereafter, as shown in FIG. 7(2), a pattern of the electromagnetic interference shielding layer 100 inserted into the printing plate 300 is taken off using a blanket 320.

Thereafter, as shown in FIG. 7(3), a pattern of the electromagnetic interference shielding layer 100 attached like a pattern of the blanket 320 is set on a front panel of the plasma display panel 200.

As described above, because an electromagnetic interference shielding layer in an implementation can be formed using a plastic process at a low temperature, after a front panel and a rear panel are coupled, the electromagnetic interference shielding layer can be directly formed on the front panel, thereby simplifying a manufacturing process and improving a process yield. Accordingly, a manufacturing time and cost can be reduced and thus a production yield can be improved.

Other features will be apparent from the description and drawings, and from the claims.

What is claimed is:

1. A filter for a plasma display apparatus comprising:
a base layer; and
an electromagnetic interference shielding layer which is disposed on the base layer and which includes a polymerized silver.

2. The filter of claim 1, wherein the electromagnetic interference shielding layer is configured as a mesh type.

3. The filter of claim 1, wherein the electromagnetic interference shielding layer is configured as a direct patterning method.

4. The filter of claim 3, wherein the direct patterning method is one of a screen printing method, an offset method, and a dispensing method.

5. The filter of claim 1, wherein the base layer includes glass or film.

6. The filter of claim 1, wherein the base layer comprises at least one of a near-infrared ray blocking material and a color temperature correcting material.

7. The filter of claim 1, wherein at least one of a near-infrared interference shielding layer and a color temperature correction layer is positioned at an upper part of the electromagnetic interference shielding layer.

8. The filter of claim 7, further comprising an anti-reflection layer positioned at the upper part of the electromagnetic interference shielding layer.

9. The filter of claim 8, wherein the anti-reflection layer comprises a plurality of materials having a different refractive index.

10. A plasma display apparatus comprising:
a front substrate;
scan electrodes and sustain electrodes arranged on the front substrate;
a rear substrate arranged a predetermined distance apart from the front substrate;
data electrodes arranged to intersect the scan electrode and the sustain electrode in the rear substrate;
barrier ribs configured to partition a discharge cell between the front substrate and the rear substrate;
a phosphor positioned within the discharge cell to discharge visible light; and
an electromagnetic interference shielding layer that is positioned over the front substrate and that includes a polymerized silver.

11. The plasma display apparatus of claim 10, wherein the electromagnetic interference shielding layer is positioned directly adjacent the front substrate.

12. The plasma display apparatus of claim 10, wherein the electromagnetic interference shielding layer is configured with a mesh type.

13. The plasma display apparatus of claim 10, wherein the electromagnetic interference shielding layer is formed with a direct patterning method.

14. The plasma display apparatus of claim 13, wherein the direct patterning method is one of a screen printing method, an offset method, and a dispensing method.

15. The plasma display apparatus of claim 10, further comprising a base film layer in an upper part of the electromagnetic interference shielding layer,
wherein the base film layer includes at least one of a near-infrared ray blocking material and a color temperature correcting material.

16. The plasma display apparatus of claim 10, wherein at least one of a near-infrared ray blocking layer and a color temperature correction layer is arranged in an upper part of the electromagnetic interference shielding layer.

17. The plasma display apparatus of claim 10, further comprising an anti-reflection layer in an upper part of the electromagnetic interference shielding layer.

18. The plasma display apparatus of claim 17, wherein the anti-reflection layer includes a plurality of materials having a different refractive index.

19. The plasma display apparatus of claim 10, further comprising a base film layer between the front substrate and the electromagnetic interference shielding layer,
wherein the base film layer includes at least one of a near-infrared ray blocking material and a color temperature correcting material.

20. The plasma display apparatus of claim 19, further comprising an anti-reflection layer in an upper part of the electromagnetic interference shielding layer.
